(19) United States
(12) Patent Application Publication
(10) Pub. No.: US 2006/0266425 A1
(43) Pub. Date: Nov. 30, 2006

(54) Control valve with a short switching time

(76) Inventors: Robert Erath, Friedrichshafen (DE); Georg Gierer, Friedrichshafen (DE); Waldemar Stark, Friedrichshafen (DE)

Correspondence Address: DAVIS & BUJOLD, P.L.L.C., 112 PLEASANT STREET, CONCORD, NH, 03301, US

(21) Appl. No.: 10/549,869

(22) PCT Filed: Mar. 20, 2004
(86) PCT No.: PCT/EP04/02939

§ 371 Date: Sep. 22, 2005

(30) Foreign Application Priority Data
Mar. 26, 2003 (DE) 103 13 484.0

(51) Int. Cl. F16K 11/052

(52) U.S. Cl. 137/625.44

(57) ABSTRACT

A control valve (12) comprising a valve housing (13) having two inflow openings (6, 7) and one outflow opening (8), in whose inner valve chamber (14), which is filled with a pressurized medium, a switching mechanism (20, 32) is displaceably arranged between two switching positions, while the switching mechanism (20, 32) respectively opens one of the inflow openings of the valve housing (13) and respectively closes the other inflow opening in both switching positions. In order to shorten the switching time in a control valve of this kind, it is provided that the switching mechanism (20, 32) comprises at least two separate sealing mechanisms (17, 18; 24, 25), which are movably arranged along respectively allocated circular arc sections approximately coaxially to the inflow openings (6, 7) in order to open and close the two openings (6, 7).

This application is a national stage completion of PCT/EP2004/002939 filed Mar. 20, 2004 which claims priority from German Application Serial No. 103 13 484.0 filed Mar. 26, 2003.

### FIELD OF THE INVENTION

The invention concerns a control valve with a short switching time.

### BACKGROUND OF THE INVENTION

Control valves configured in this way have been known for quite some time and are preferably used in hydraulic or pneumatic control devices. A known control valve 1 such as this is illustrated by way of example in FIG. 2. It comprises a valve housing 2 containing openings 6, 7 for feeding a pressurized control medium as well as an opening 8 for the discharge of the pressurized control medium. Control pressure lines, which are not illustrated here, can be connected to these openings. A switching means 4 configured as a ball, which is disposed in an inner chamber 3 of the valve housing 2, is arranged in such way that it can be freely displaced along a directional arrow 5 and either closes the inflow opening 6 or the inflow opening 7 and alternately respectively opens the other inflow opening.

Such an “OR-ball valve” is used in control devices in such a way that, for example, the pressurized control medium entering the valve housing 2 via the opening 6 with an inflow 9 has a pressure that is lower than the same pressurized control medium, which can enter the valve housing with a second inflow 10 through the opening 7. In this way, the pressurized control medium leaves the control valve 1 via the outflow opening 8 at a lower or at a higher control pressure depending on the position of the switch.

A control valve having the above-described OR-function can also be advantageously used in control devices for automatic transmissions, in which the latter, for example, in order to carry out changes in the gear transmission ratio, pressurize one or several gearbox actuators with differently high control pressures. Unfortunately these “OR-ball valves,” which have a very simple design, in particular, can not be used if a very short switching time is required, since the shift path of the switching ball 4, and hence the switching time, are comparatively long.

When using such a ball valve, for example, in an automatic motor vehicle stepped gear transmission during a complex 5-4-3-2 downshift, an undesirable pressure may occur on the actuators of a gear clutch that are to be switched on and/or off, which is perceived by the driver of the vehicle as a decrease in shifting quality. The cause of this disadvantageous switching characteristic is that the actuator of the clutch that is to be switched off is connected to the actuator of the clutch for an unpleasantly long period which is to be switched on during the switching of the ball valve.

In light of this background information, it is the object of the invention to create a control valve, which can achieve shorter switching times than those possible with the described ball control valve.

### SUMMARY OF THE INVENTION

Accordingly, the control valve comprises the valve housing, which is provided with two inflow openings and one outflow opening, in whose inner chamber, which is filled with a pressurized medium, the switching means between two switching positions is displaceably arranged. This switching means can respectively close one of the inflow openings of the valve housing in two switching positions, while the other inflow opening is opened.

In order to achieve the desired fast switching reaction, it is provided that this switching means comprises two separate sealing means, which are disposed in the valve housing along respectively allocated circular arc sections, in such a way that they can pivot substantially coaxially to the inflow openings so as to open and close these inflow openings. The closing and the opening processes can take place simultaneously by way of these two separate sealing means, which is reflected in a clearly shorter overall actuation time for such a switching operation.

In an advantageous embodiment of the control valve, according to the invention, the switching means is designed in such a way that it can be pivotally arranged around an axis of rotation in the inner chamber of the valve housing, so that a closing motion of one sealing means is mechanically coupled to an opening motion of the other sealing means. This mechanical coupling of the two separate sealing means occurs preferably by way of a separate connecting piece which, in the simplest case, is configured as a preferably cylindrical steering rod.

The actual sealing means can have a spherical geometry so that a comparatively good sealing effect is to be expected. On the other hand, when using spherical sealing means, it is necessary that these be aligned very accurately on their sealing seats in the area of the inflow and/or outflow openings on the valve housing. For this reason, a flap-shaped sealing means geometry, in which the sealing flaps can sealingly cover their allocated valve housing openings, is considered especially advantageous.

In an especially preferred control valve, two shaft ends that face radially away from a connecting piece are configured on said switching means between the two separate sealing means, which are provided for the purpose of pivotable mounting of the switching means in the valve housing, and these shaft ends are seated in receiving openings, such as blind holes of the valve housing. In this control valve, in addition, two switching balls, switching hemispheres or switching flaps, which are disposed substantially perpendicular to the axis of rotation of the shaft ends, are arranged on the connecting piece and facing radially away therefrom.

At least two upper sealing surfaces aligned substantially perpendicular to the axis of rotation of the shaft ends as well as substantially perpendicular to the longitudinal axis of the switching means are provided on the two switching flaps.

It is understood that the described control valve is configured as an “OR-valve” in each one of the described variants, with which it is possible to adjust a first or a second switching position. Such a control valve is preferably an integral part of a hydraulic or pneumatic control device, even though it can be used alone in order to pressurize one or several pressure lines with preferably two different pressures.

According to the invention, the control valve can be used particularly advantageously as an integral component of a hydraulic or pneumatic gear control device, especially in a valve gate housing of an automatic transmission, wherein a separate valve housing can be omitted, since the walls of adjoining control pressure channels fulfill the function of the valve housing walls.

Finally, it should be pointed out that the control valve can be produced very inexpensively as an injection molded component made of metal or plastic.

### BRIEF DESCRIPTION OF THE DRAWINGS

The invention will now be described, by way of example, with reference to the accompanying drawings in which:

FIG. 1 is a schematic cross-sectional illustration of a control valve configured according to the invention;

FIG. 2 is an “OR-control valve” according to the state of the art;

FIG. 3 is a perspective illustration of a switching means of a control valve configured according to the invention; and

FIG. 4 is a section of a diagram of a hydraulic control system of an automatic transmission having an integrated control valve.

### DETAILED DESCRIPTION OF THE INVENTION

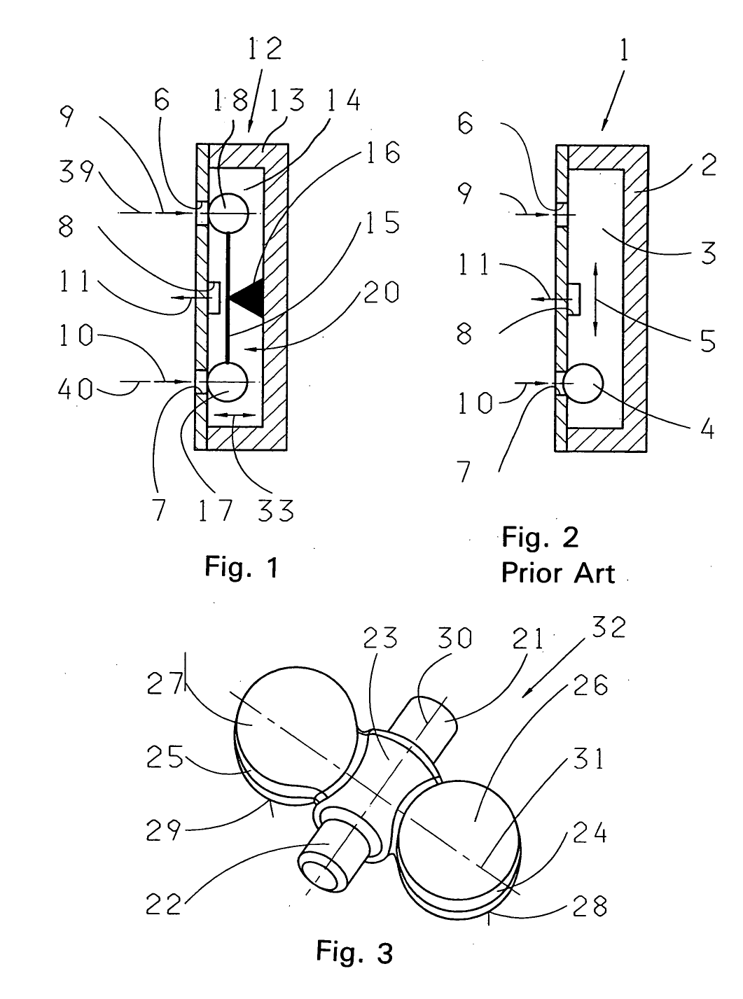

A comparison of the control valve, according to the state of the art, as described at the beginning, (FIG. 2) with a control valve 12, according to the invention shown in FIG. 1, shows that the latter also comprises a valve housing 13, in whose inner chamber 14 a switching means 20 is disposed for alternately opening and closing two pressurized medium inflow openings 6, 7. In this way, it is possible to pressurize an outflow opening 8 with two different control pressures.

The switching means in the exemplary embodiment, shown in FIG. 1, consists a connecting piece 15, which is pivotably or tiltably arranged in a bearing 16, at whose ends a sealing means is configured in the form of a sealing ball 17, 18. These two sealing balls 17, 18 are shaped and positioned with respect to their diameters and their positions in the valve housing 13 in such a way that, with them, the two inflow openings 6, 7 can be alternately sealed in a pressure-tight manner. In this configuration, the bearing 16 acts like the bearing of a rocker, so that the inflow opening 9 guided toward the control valve 12 through the housing opening 6 acts upon the aforementioned sealing ball 18, and moves the latter along a circular arc section to the right away from the inflow opening 6. Since the sealing ball 18 is mechanically connected to the second sealing ball 17 by way of the connecting piece 15, said ball moves along a circular arc section to the left, according to the directional arrow 33, until it closes the second inflow opening 7. An outflow path, via the outflow opening 8, remains open to the pressurized control medium, which has been fed into the valve housing 13, so that an outflow 11 leaves the control valve 12 via said opening at the first control pressure level.

In the second possible switching position of the control valve 12, the inflow 10 acts upon the sealing ball 17 closing the inflow opening 7 at a preferably higher control pressure level so that the sealing ball 17 moves to the right in the opening direction and the sealing ball 18 moves to the left towards the opening 6 in the closing direction until the latter has been closed. In this way, the control pressure prevailing in the inflow opening 10 can also be applied to the inner valve chamber 14, so that this control pressure is the same as the one of the outflow opening 11 passing the outflow opening 8.

Apart from the configuration illustrated in FIG. 1, the switching means of the control valve according to the invention can also be designed as is illustrated in FIG. 3. In this design variation, the switching means 32, which is preferably injection-molded from a polymer or is made of metal, comprises a central connecting piece 23, on which two opposing switching flaps 24, 25 are disposed along a longitudinal axis 31 of the switching means 32. Each one of these switching flaps 24, 25 comprises an upper sealing surface 26, 27 and a lower sealing surface 28, 29, respectively, which allow an alternate closing or opening of the inflow or outflow openings in the control valve housing. In addition, radially opposite extending shaft ends 21, 22 are arranged on the connecting piece 23, and these are mounted in such a way in the valve housing 13, that the switching means 32 can be pivoted around an axis of rotation 30 of the shaft ends 21, 22.

The sealing balls 17,18 or the sealing flaps 24, 25 are moved in such a way during an actuation of the valve in the valve housing 13 that they follow, in response to the pivoting, the respectively allocated circular arc sections, which can be considered as being aligned substantially coaxially to central longitudinal axes 39, 40 of the inflow openings 6, 7, because of the comparatively small actuation paths.

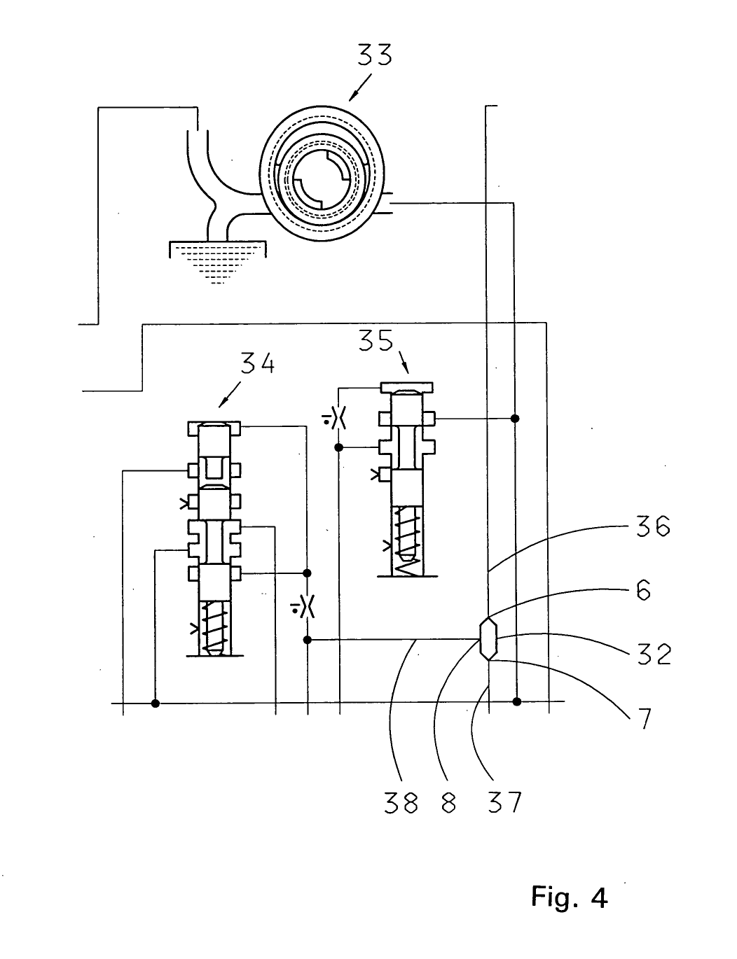

According to FIG. 4, as the section of a hydraulic diagram shows, a control valve 32, which is illustrated here only symbolically, but is configured in accordance with the invention, can very advantageously be used in a hydraulic gear control system, which can be integrated as an integral part in a valve gate housing of and automatic transmission. As this illustration indicates, the hydraulic gear control system also comprises a pressurized medium pump 33 that generates a main control pressure, two pressure regulating valves 34, 35, and the control valve 32, according to the invention, which is connected to inflow lines 36, 37 with its inflow openings 6, 7 and an outflow line 38 with its outflow opening 8.

Comparative tests with a control valve according to the state of the art of FIG. 2 as well as with a control valve configured according to the invention showed, both in a test setup and in a gear control device in a motor vehicle, that the switching time is shorter by a factor of 8 using the control valve according to the invention at a hydraulic fluid temperature of −15° C. and shorter by a factor of 4 at a hydraulic fluid temperature of 100° C. than if the known ball control valve is used. The shifting quality deteriorations described above could not be detected, therefore, if the control valve is configured according to the invention.

Reference Numerals

1 control valve (state of the art)
2 valve housing
3 inner valve chamber
4 switching means (ball)
5 direction of motion
6 inflow opening
7 inflow opening
8 outflow opening
9 inflow opening
10 inflow opening
11 outflow opening
12 control valve
13 valve housing
14 inner valve chamber
15 connecting piece
16 bearing
17 sealing ball
18 sealing ball
20 switching means
21 shaft end
22 shaft end
23 connecting piece
24 sealing flap
25 sealing flap
26 first upper sealing surface
27 second upper sealing surface
28 first lower sealing surface
29 second lower sealing surface
30 axis of rotation
31 longitudinal axis of switching means
32 switching means; control valve
33 direction of motion
34 regulating valve; pressurized medium pump
35 regulating valve
36 inflow line
37 inflow line
38 outflow line
39 central longitudinal axis of a valve housing opening
40 central longitudinal axis of a valve housing opening

1-12. (canceled)

13. A control valve (12) comprising a valve housing (13) having two inflow openings (6, 7) and one outflow opening (8), in whose inner chamber (14), which is filled with a pressurized medium, is displaceably arranged a switching means (20, 32) between two switching positions, in which
the switching means (20, 32) opens one of the inflow openings of the valve housing (13) and closes the respectively other inflow opening in both switching positions,
the switching means (20, 32) comprises two separate sealing means (17, 18; 24, 25), which are displaceably arranged in the valve housing (13) along respectively allocated circular arc sections approximately coaxially to the inflow openings (6, 7) in order to open and close the two openings (6, 7),
the switching means (20, 32) is arranged in the inner chamber (14) of the valve housing (13) so as to freely pivot around one of an axis of rotation or a tilting axis (30),
the two separate sealing means (17, 18; 24, 25) of the switching means (20, 32) are connected to each other via a connecting piece (15, 23),
the switching means (20, 32) has two shaft ends (21, 22) that extend radially away from the connecting piece, which are mounted in receiving openings, preferably in blind holes of the valve housing (13),
two switching balls (17, 18) or switching flaps (24, 25) that extend radially away from the connecting piece (23) are disposed essentially perpendicular to the axis of rotation (30) of the shaft ends (21, 22), and
the switching flaps (24, 25) have at least two upper sealing surfaces (26, 27), which are aligned essentially perpendicular to the axis of rotation (30) as well as essentially perpendicular to a longitudinal axis (31) of the switching means (32),
the switching means (20, 32) cannot be mechanically actuated.

14. The control valve according to claim 13, wherein the sealing means (17, 18; 24, 25) are configured in one of a spherical or flap shape.

15. The control valve according to claim 13, wherein lower sealing surfaces (28, 29) are configured opposite the upper sealing surfaces (26, 27).

16. The control valve according to claim 13, is configured as an “OR-valve”, with which can be adjusted one of a first or a second switching position.

17. The control valve according to claim 13, being an integral part of one of a hydraulic or pneumatic control device.

18. The control valve according to claim 17, being an integral part of one of a hydraulic or pneumatic gear control device, integrated especially in a valve gate housing of an automatic transmission.

19. The control valve according to claim 13, being an injection-molded part made of one of metal or plastic.
